(19) United States
(12) Patent Application Publication
(10) Pub. No.: US 2025/0085618 A1
(43) Pub. Date: Mar. 13, 2025

(54) ADJUSTABLE L-BRACKET

(71) Applicant: Really Right Stuff, LLC, Lehi, UT (US)

(72) Inventors: Verent CHAN, Lehi, UT (US); Joseph M. JOHNSON, SR., Lehi, UT (US)

(73) Assignee: Really Right Stuff, LLC, Lehi, UT (US)

(21) Appl. No.: 18/799,437

(22) Filed: Aug. 9, 2024

Related U.S. Application Data
(60) Provisional application No. 63/581,174, filed on Sep. 7, 2023.

(51) Int. Cl. G03B 17/56

(52) U.S. Cl. CPC G03B 17/561

(57) ABSTRACT

An adjustable L-bracket.

### CROSS REFERENCE TO RELATED APPLICATIONS

The present application claims the benefit of U.S. Provisional Patent Application Ser. No. 63/581,174 filed Sep. 7, 2023.

### BACKGROUND

The subject matter of this application relates to an adjustable L-bracket.

Camera equipment often includes a threaded receptacle for attaching the equipment to a head mount of a tripod, monopod or other support. A camera may be attached directly to a head mount of a support by a screw projecting from the head mount but a quick-release mounting system is commonly used to secure camera equipment, particularly higher end camera equipment, to a tripod or other support. A quick-release camera mounting system typically includes a plate that is securable to the camera' body by a screw that is engageable with the threaded receptacle in the bottom of the camera. The screw projecting from the head mount provides a means of securing a receiver to the tripod or other camera support. A projection or taper of the camera plate engages a complementary groove or taper of the receiver and the camera plate is typically secured in the receiver by a clamp or other quick-release mechanism. For example, many makers of photographic equipment utilize a quick-release system developed by camera equipment maker Arca-Swiss, International. The Arca-Swiss or arca-type quick-release system utilizes a dovetail tenon in the form of a 38 mm wide plate having at least two opposing edges sloping at 45 degrees. The plate is receivable and securable in a receiver by opposing sloping dovetail surfaces of a clamp, usually operable by a lever or screw, such as the quick-release clamp described in U.S. Pat. No. 6,773,172. The receiver may be attached to the head mount or, more commonly, to an intermediate attaching device, such as a ballhead, pan head or gimbal head, affixed to the head mount.

A ballhead typically comprises a ball which has a radially projecting stem and which is supported in a socket in the ballhead's body. The body of the ballhead is secured to the head mount of a tripod or other support by the screw projecting from the head mount and engaging a threaded aperture in the bottom of the ballhead's body. Camera equipment or a receiver, such as a clamp of a quick-release system, is attached to the end of the stem projecting from the ball by a screw threaded into a longitudinally extending aperture in the stem. The ball and socket joint enables rotation of the ball in the body of the ballhead and the body, typically, includes a mechanism enabling constriction of the socket to lock the ball and the attached camera equipment in a desired attitude relative to the support. While the ball can be rotated 360° around the longitudinal axis of the stem, rotation in directions transverse to the axis of the stem is limited by interference between the stem and the edge of the ballhead's body.

The body of a ballhead may include one or more drop notches providing clearance for the stem to rotate 90° in a direction transverse to the axis of the stem enabling the camera equipment to be moved from a landscape orientation to a portrait orientation and vice versa. Changing the orientation of camera equipment attached to a ballhead from landscape to portrait or vice versa can be problematic. The camera equipment is offset relative to the center of rotation of the ball and as the ball is rotated in directions transverse to the longitudinal axis of the stem the camera shifts both horizontally and vertically. If the camera equipment is heavy, the horizontal movement of the weight may destabilize the support and the vertical displacement of the camera may make using the viewfinder difficult. In addition, shifting the location of the camera's lens will change the setup for the shot particularly if the subject is close, for example, when shooting a macro. It may be necessary to move the tripod to compensate for the change in the relative positions of the camera and the subject. In addition, if the support is not sitting on a level surface, it may not be possible to rotate the ball far enough to attain the portrait orientation before the stem of the ball makes contact with the bottom of the drop notch.

Attaching camera equipment to a support with a L-plate or L-bracket avoids the need to utilize a ballhead drop notch when switching a supported camera from landscape orientation to portrait orientation or vice versa. A L-plate includes a first portion attachable to the bottom of the camera's body and a second portion partially wrapping around the camera's body to extend normal to the first portion and parallel to the side of the camera's body. Each portion of the L-plate includes a retention feature, for example, a tenon of a dovetail, enabling engagement with a receiver portion, for example, an Arca-Swiss type quick-release clamp, when the camera equipment is in either one of the two perpendicular photographic orientations. To switch a camera from a landscape orientation to a portrait orientation, the photographer releases the quick-release device, rotates the camera ninety degrees, and engages and locks the mounting feature of the second portion of the L-plate in the receiver of the quick release system. The camera's lens is, typically, substantially centered with respect to the longitudinal axis of the L-plate's two mounting features and movement of the lens relative to the head mount of the support is minimized when the camera's orientation is changed.

While an L-plate facilitates photography with a tripod, monopod or other support, use of an L-plate with a digital camera can be problematic. Digital cameras are commonly connectable to remote devices, such as a computer, a printer or a video monitor, for downloading and viewing images and video captured with the camera. In addition, remote accessories, such as a microphone, a flash unit or a remote shutter control switch, may be connected to the camera. The connectors for the cable assemblies connecting these remote devices to the camera are commonly located behind one or more doors on the side of the camera's body and when the L-plate and camera are turned for the portrait orientation, there is, typically, insufficient distance between the body of the camera and the L-plate and/or the receiver of the quick-release system to accommodate passage of the cable assembly(ies) connecting the camera to the remote device(s). A cable relief spacer may be inserted between the L-plate and the receiver to provide clearance for connectors and cables but this is, typically, a small, loose piece which can be easily misplaced and may not be carried with the camera equipment and, therefore, may be unavailable when needed.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates a perspective view of an exemplary L-bracket.

FIG. 2 illustrates a front view of the L-bracket of FIG. 1.

FIG. 3 illustrates a left view of the L-bracket of FIG. 1.

FIG. 4 illustrates a right view of the L-bracket of FIG. 1.

FIG. 5 illustrates a top view of the L-bracket of FIG. 1.

FIG. 6 illustrates a bottom view of the L-bracket of FIG. 1.

FIG. 7 illustrates a back view of the L-bracket of FIG. 1.

FIG. 8 illustrates a view of a lower base plate and a side plate.

FIG. 9 illustrates another view of the lower base plate and the side plate.

FIG. 10 illustrates a view of the lower base plate, a middle base plate, and the side plate.

FIG. 11 illustrates another view of the lower base plate, the middle base plate, and the side plate.

FIG. 12 illustrates a view of the lower base plate, the middle base plate, an upper base plate, and the side plate.

FIG. 13 illustrates another view of the lower base plate, the middle base plate, the upper base plate, and the side plate.

FIG. 14 illustrates another view of the lower base plate, the middle base plate, the upper base plate, and the side plate.

FIG. 15 illustrates another view of the lower base plate, the middle base plate, the upper base plate, and the side plate.

FIG. 16 illustrates a quick release swivel.

FIG. 17 illustrates another view of the lower base plate, the middle base plate, the upper base plate, and the side plate.

### DETAILED DESCRIPTION

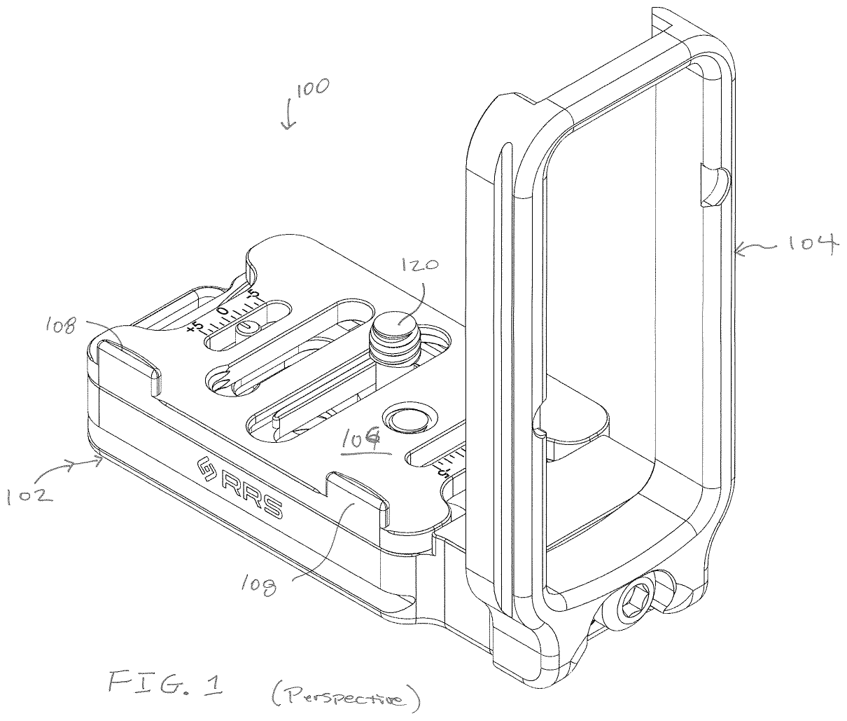

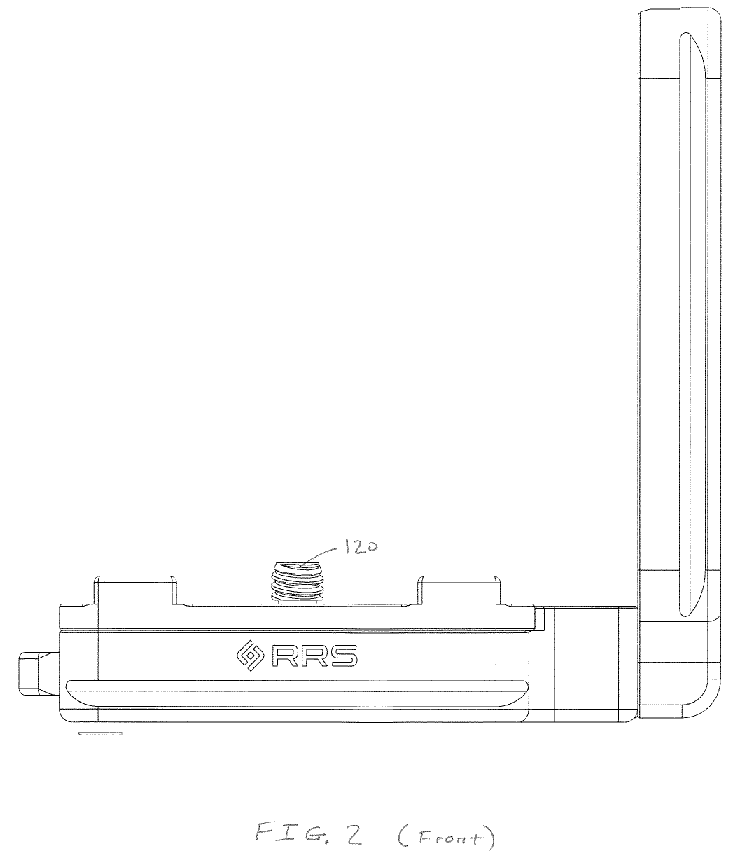

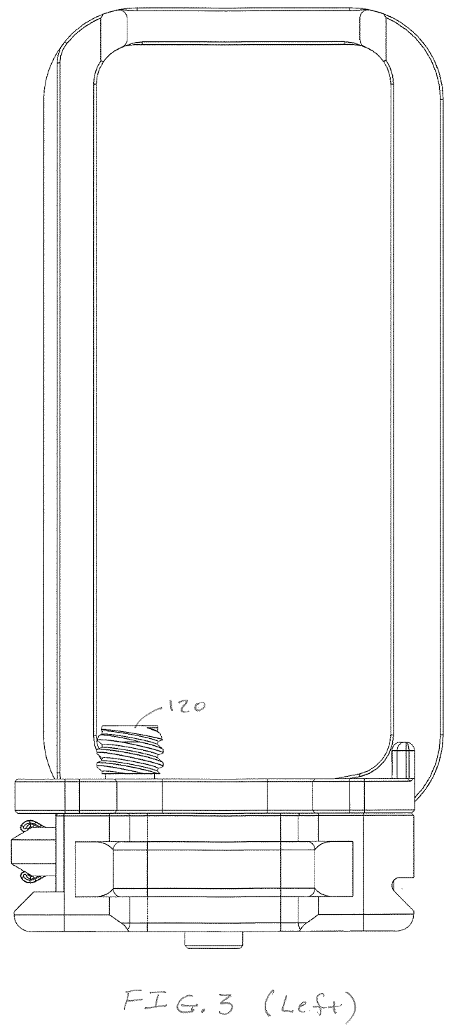

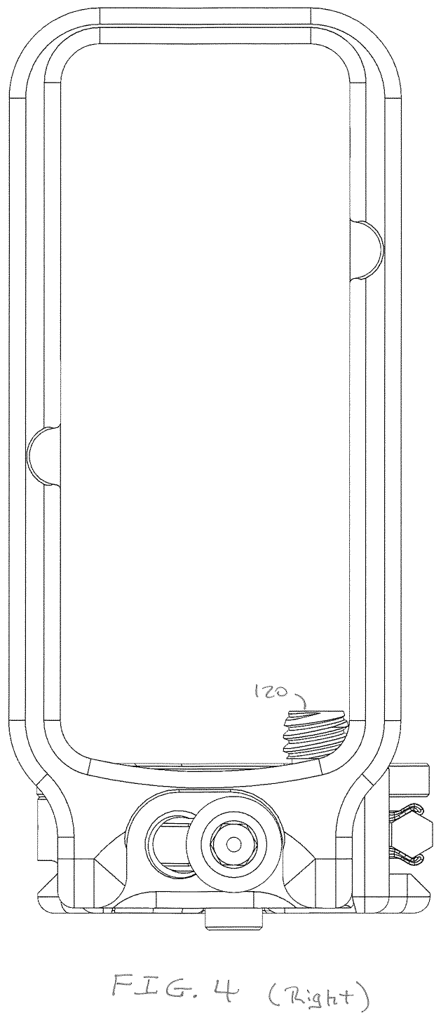

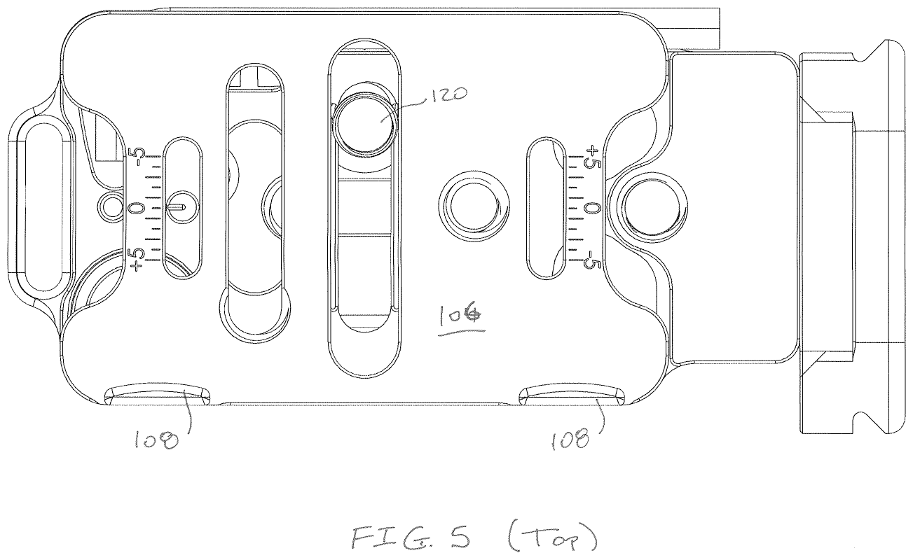

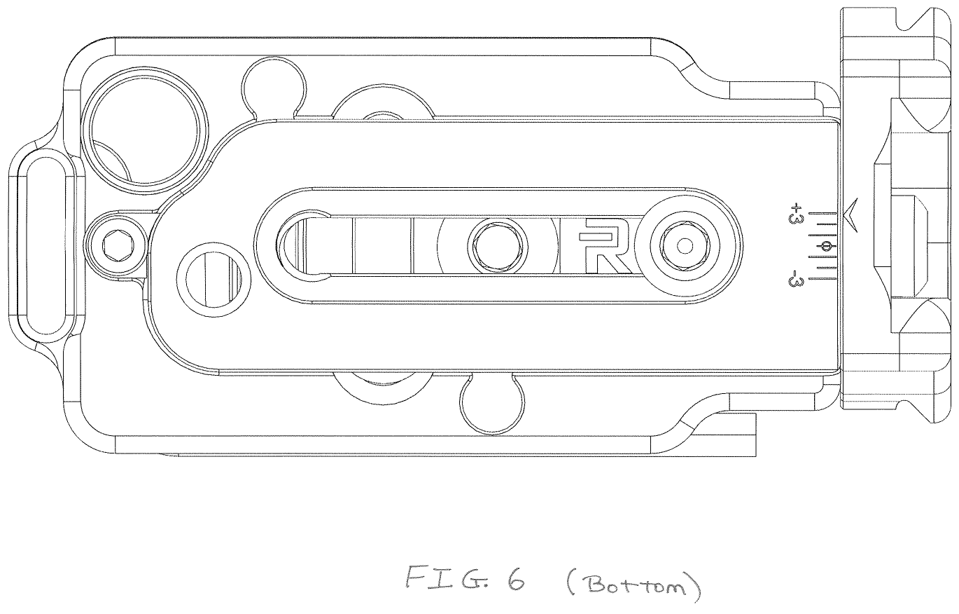

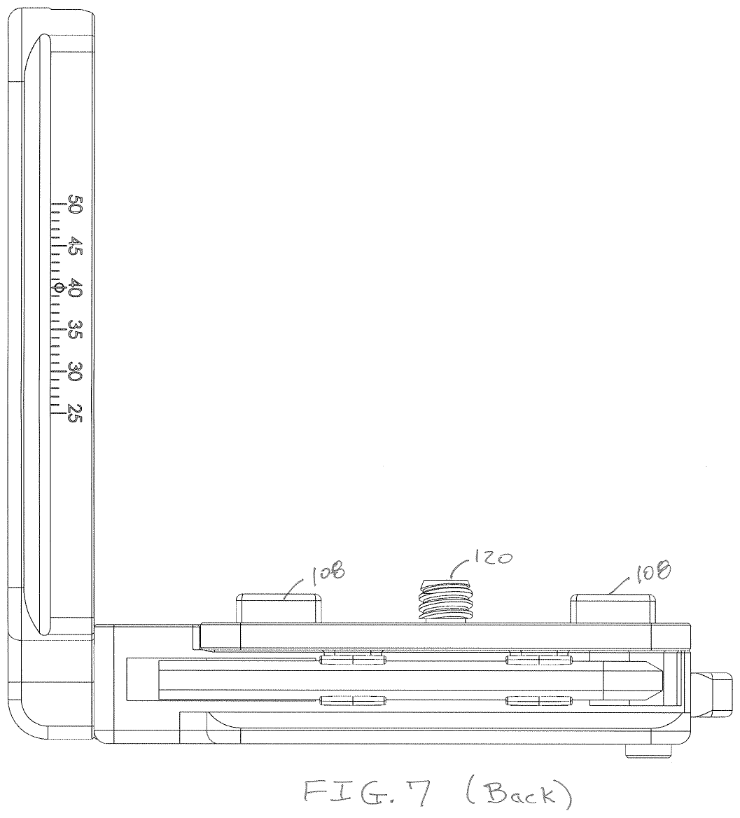

Referring to FIG. 1 a perspective view of an exemplary L-bracket 100 is illustrated for mounting equipment, such as imaging device, on a support. The L-bracket 100 comprises a base member or plate 102, preferably comprised of multiple components, and a side member or plate 104 projecting substantially normal to the base plate to wrap around and extend parallel to the side of the imaging device's body. FIG. 2 illustrates a front view of the L-bracket 100. FIG. 3 illustrates a left view of the L-bracket 100. FIG. 4 illustrates a right view of the L-bracket 100. FIG. 5 illustrates a top view of the L-bracket 100. FIG. 6 illustrates a bottom view of the L-bracket 100. FIG. 7 illustrates a back view of the L-bracket 100. The base plate 102 preferably has an upper imaging device interface portion 106 adapted to receive and restrain a lower side surface of the body of the imaging device. At least one of the edges of interface portion 106 includes one or more upwardly projecting edges 108, which may engage with a front or rear surface of a lower portion of the imaging device. Preferably, there are a plurality of upwardly projecting edges 108 that are spaced apart from one another, and more preferably two upwardly projecting edges 108. In many cases, the lower front or rear surface of the body of the imaging device is slightly curved, which by having two contacting upwardly projecting edges 108 maintains a face-to-face engagement which inhibits rotation of the imaging device generally independent of the particular curve of the lower front or rear surface of the body of the imaging device. Referring also to FIG. 5, preferably each of the upwardly projecting edges 108 include curved surfaces so that a further improved contact may be made with the lower front or rear surface of the body of the imaging device by only having a single point of contact with each of the upwardly projecting edges 108. The engagement of the upwardly projecting edges 108 restrains the camera against twisting about an axis normal to the surface of the upper portion without the need for an intervening layer of friction material which could enhance vibrational freedom of the camera. The interface portion of the base plate also includes a threaded aperture which aligns with a threaded opening in the base of the imaging device which is engageable by a screw 120 that projects upward through the upper surface of the base plate 102. Also, the screw 120 may include a shank with an unthreaded portion proximate the screw's head which permits the screw to rotate in a threaded hole in the base plate without backing out.

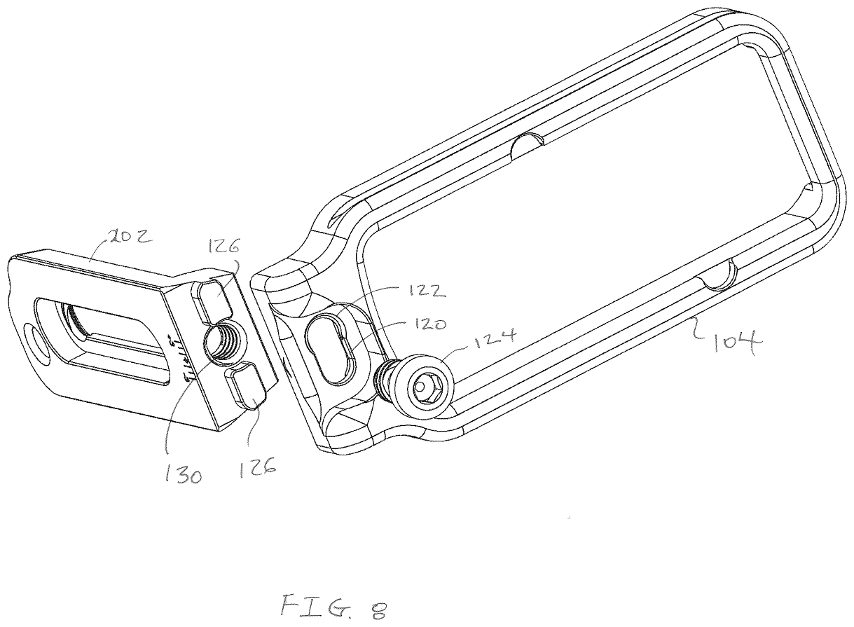

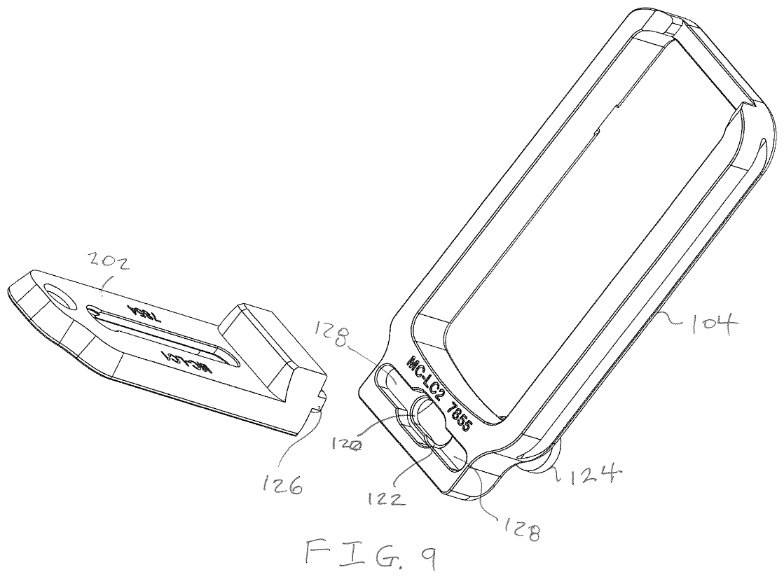

In many cases, an imaging device often includes a set of ports on the side thereof, such as control and networking cables. It is desirable that the cut out of the side plate 104 is at least a majority of the side plate so that the cables may be inserted therethrough to interconnect to the imaging device. However, in some cases the ports for a particular imaging device may not be suitably aligned with the side plate 104. Referring to FIG. 8 and FIG. 9, the side plate 104 may define an elongate opening 120 with threads on an end 122 thereof. A threaded screw 124 is engaged with the threads on the end 122 so that the threaded screw 124 is retained within the elongate opening 120. The threaded screw 124 preferably includes a shank with an unthreaded portion proximate the screw's head. In this manner, the threaded screw 124 may slide horizontally along the longitudinal axis of the elongate opening 120. The threaded screw 124 engages with a threaded opening 130 defined by the lower base plate 202. The side plate 104 may be secured to the lower base plate 202 (a portion of the entire base plate thereof described later) by rotation of the threaded screw 124. Also, the side plate may be slid horizontally along the longitudinal axis of the elongate opening 120 so that the opening defined by the side plate 104 may be shifted with respect to the base plate 102. Once the desired alignment is achieved, the side plate 104 is secured to the lower base plate 202 by rotation of the threaded screw 124. To provide increased resistance of the side plate 104 twisting with respect to the bottom plate 102, one or more stubs 126 may be provided which fit within a matching opening 128 defined by the side plate 104. The spacing between the exterior ends of the stubs 126 is preferably less than the width of the matching opening 128 so that there is space for sliding horizontally. The side plate 104 may include a leg portion that is perpendicular to the side plate 104, if desired. By way of example, the side plate 104 may slide horizontally between 3 mm and 10 mm. Also, in some cases a flip out display of the imaging device may not fully open because the side plate 104 is in its way. In this case, the side plate 104 may be horizontally slid out of the way and secured to the lower base plate 202.

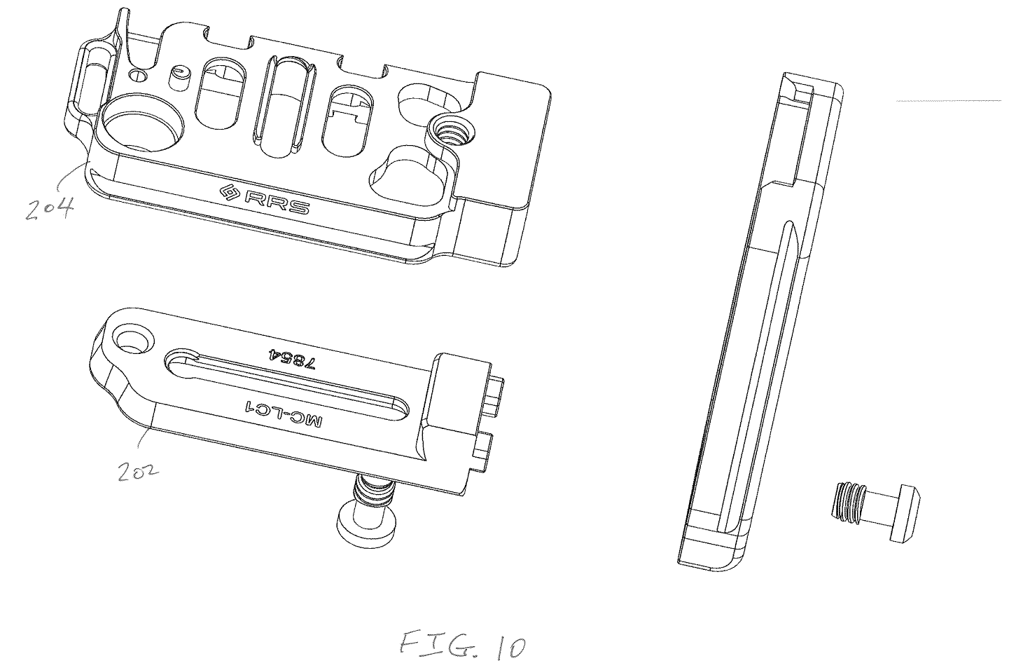

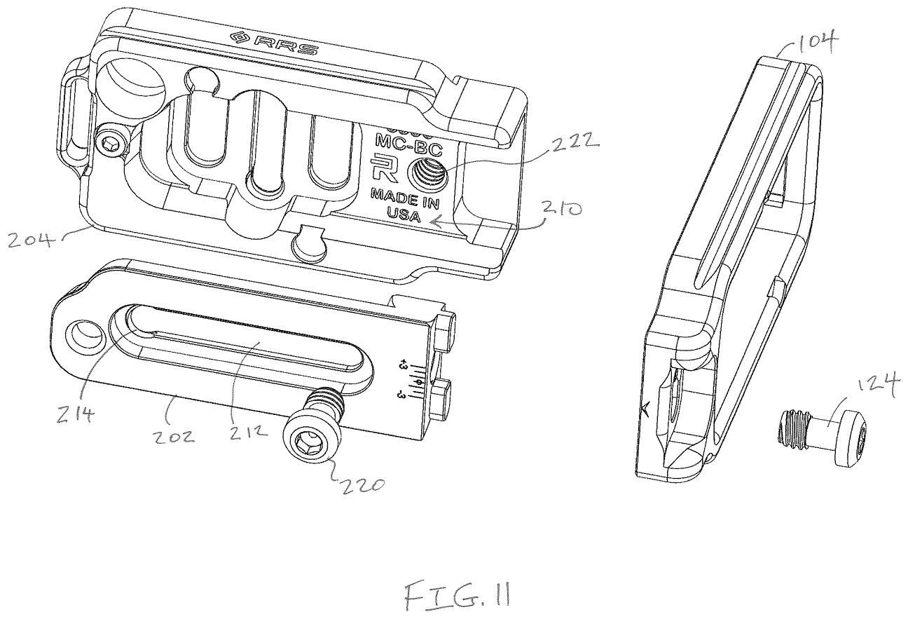

Referring to FIG. 10 and FIG. 11, the base plate 102 may include the lower base plate 202 and a middle base plate 204. The lower base plate 202 may be maintained within a recess 210 defined by the middle base plate 204. The lower base plate 202 is slidably engaged with the middle base plate 204 along a longitudinal axis of the middle base plate 204 and/or the lower base plate 202. The lower base plate 202 includes an elongate opening 212 that includes a threaded portion 214 at an end thereof to receive a screw 220. The screw 220 projects upward through the elongate opening 212 of the lower base plate 202 may include a shank with an unthreaded portion proximate the screw's head which permits the screw to rotate in the elongate opening 212 without backing out. The screw 220 may slide within the opening 212, as desired. With the lower base plate 202 secured to the side plate 104, the side plate 104 may be adjusted in its horizontal position with respect to the middle base plate 204. In this manner, the side plate 104 may be adjusted to accommodate the width of the imaging device. The screw 220 is rotated into a threaded opening 222 in the middle base plate 204 to secure the lower base plate 202 from sliding with respect to the middle base plate 204 and likewise secure the side plate 104 from sliding with respect to the middle base plate 204 and/or the lower base plate 202.

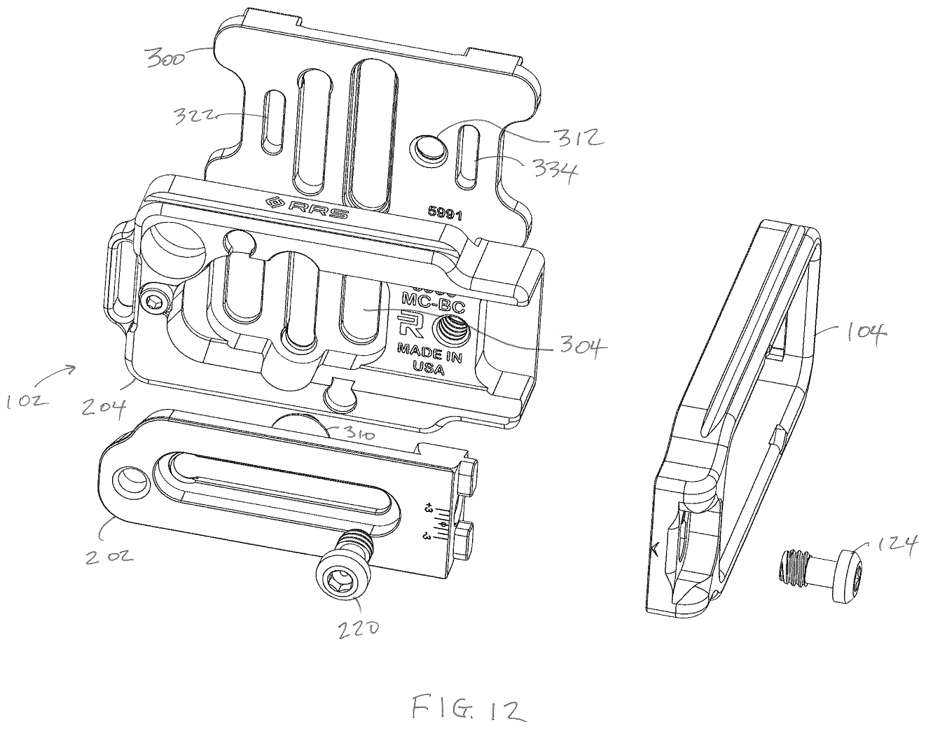

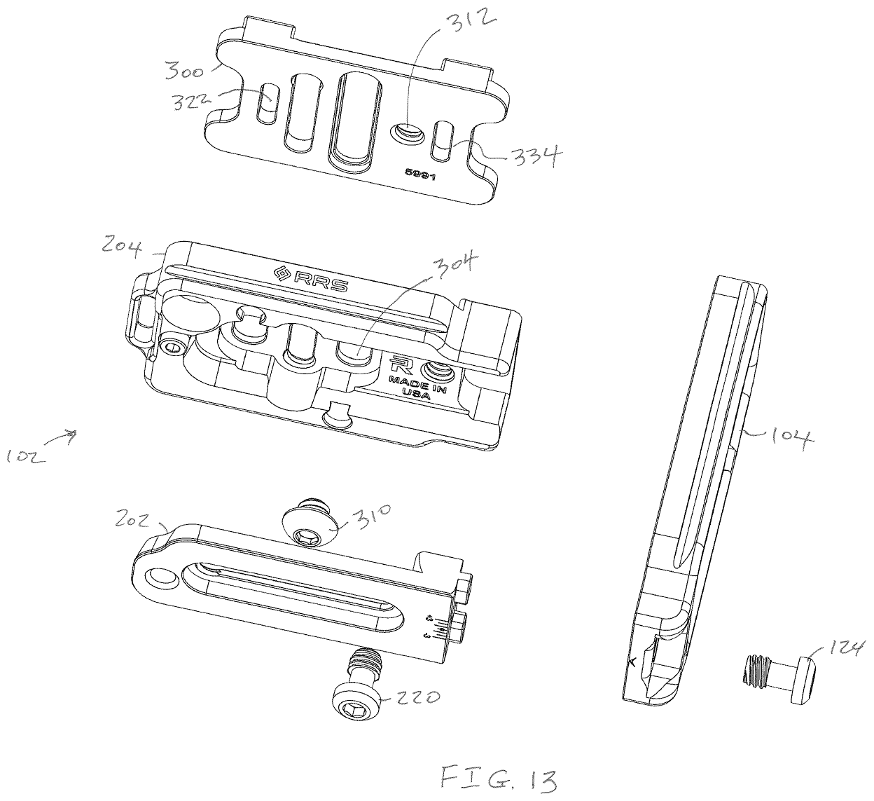

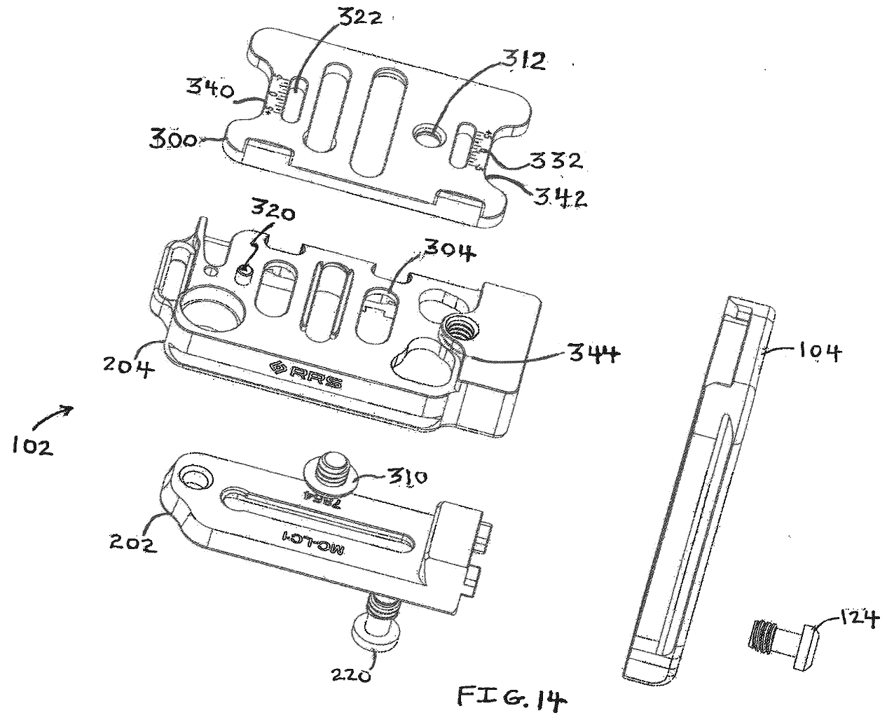

In many cases, different imaging devices tend to have different widths between a lower threaded opening of the imaging device that is secured to the L-bracket and the front and/or rear lower upright surface of the imaging device. To accommodate the different widths so that the upwardly projecting edges 108 are in face-to-face engagement with the imaging device the spacing between the upwardly projecting edges 108 and the screw 120 it is desirable that the spacing is adjustable. Referring to FIG. 12, FIG. 13, and FIG. 14, the base plate 102 may include the lower base plate 202, the middle base plate 204, and an upper base plate 300 arranged in a stacked structure. The middle base plate 204 may define an elongate opening 304 with a threaded end portion thereof. A screw 310 projects upward through the elongate opening 304 of the middle base plate 204 may include a shank with an unthreaded portion proximate the screw's head which permits the screw to rotate in the elongate opening 304 without backing out. The screw 310 may slide within the opening, as desired. The upper base plate 300 may include a threaded opening 312. The screw 310 is inserted within the elongate opening 304 of the middle base plate 204 and is secured to the threaded opening 312 of the upper base plate 300. The upper base plate 300 may slide in a perpendicular direction with respect to the longitudinal axis of the base plate 102 so that the upwardly projecting edges 108 may be adjustably positioned with respect to the screw 120 that secures the imaging device to the L-bracket 100. The screw 310 is rotated to secure the middle base plate 204 to the upper base plate 300 such that the spacing between the screw 310 and the upwardly projecting edges 108 are adjusted, as desired.

The middle base plate 204 may include a pin (or other projection) 320. The upper base plate 300 may include an elongate slot 322 within which the pin 320 is positioned. In this manner, the pin 320 and elongate slot 322 assist with inhibiting the upper base plate 300 from rotating with respect to the middle base plate 204 and/or the lower base plate 202.

The middle base plate 204 may include another elongate slot 334. The middle base plate 204 may be rotated 180 degrees so that the upwardly projecting edges 108 may be switched from one side to the other side to engage the other side of the imaging device. With the middle base plate 204 reversed, the screw 310 is engaged with the threaded opening 334 and the elongate slot 334 is engaged with the pin 320. Opposing end notches 340 and 342 of the upper base plate 300 are engaged with a projection 344 of the middle base plate 204 to further inhibit rotation of the upper base plate 300 with respect to the lower base plate 204. In this manner, the same upper base plate 340 may be used for different imaging devices with the upwardly projecting edges 108 engaged with either the front and/or the back of the imaging device, as desired.

Preferably, a set of different upper base plates may be included with the remainder of the L-bracket so that customized upper base plates may be provided specifically sized for a particular imaging device.

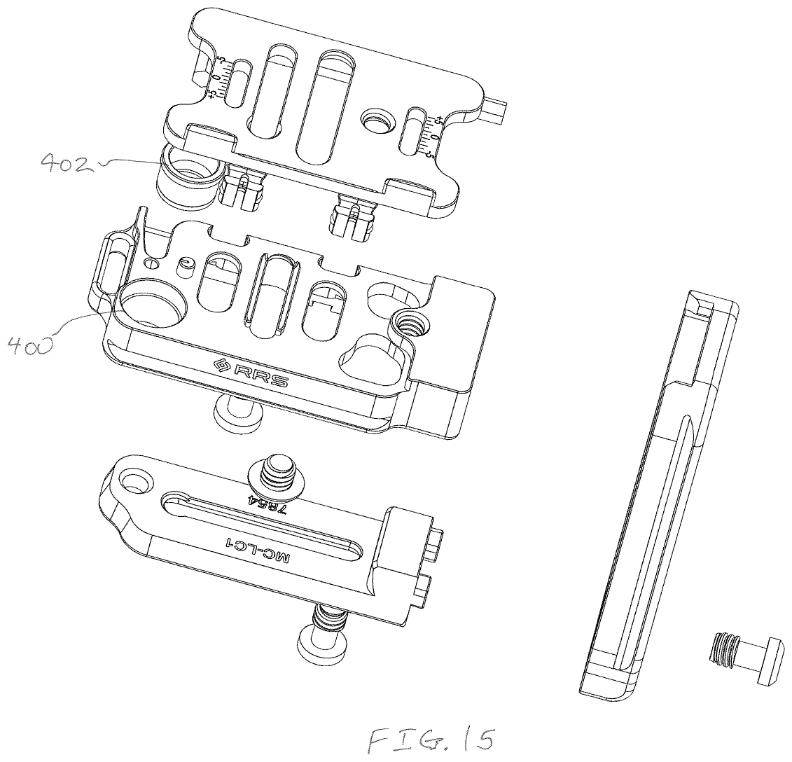

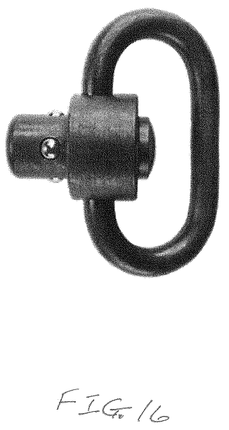

Referring to FIG. 15, the middle base plate 204 may define an opening 400 into which is included an insert 402. The insert 402 is circular with an upper portion having a first diameter, a central portion having a second diameter greater than the first diameter, and a lower portion having a third diameter that is less than the second diameter and preferably the same as the first diameter. Referring to FIG. 16, the insert 402 is suitable for a being engaged by a quick disconnect sling swivel where the plurality of circular bearings are rescissible and engage with the central portion of the insert 402. The insert 402 is not accessible from the top of the bottom plate 102 and is accessible from the bottom of the bottom plate 102.

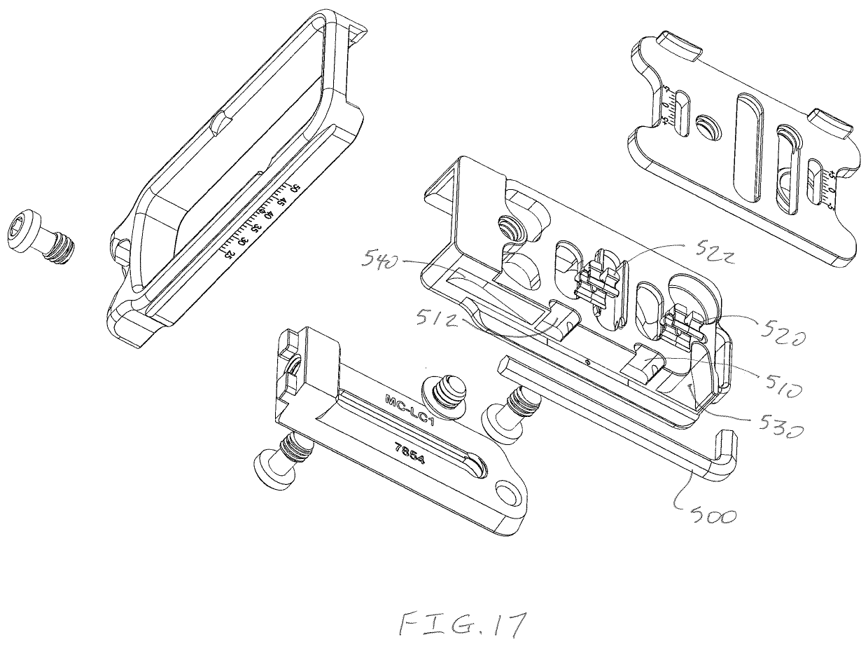

Referring to FIG. 17 the L-bracket may include a support for an Allen wrench 500. The middle base plate 204 may define a pair of openings 510, 512 into which are secured a pair of resilient Allen wrench clips 520, 522. The middle base plate 204 defines an opening 530 to allow the curved end of the Allen wrench 500 to be positioned therein. The middle base plate 204 defines an opening 540 to allow the straight end of the Allen wrench 500 to be pressed therein to detach the Allen wrench 500 from the Allen wrench clips 520, 522. In this manner, the Allen wrench 500 may be tilted to facilitate the removal thereof from the middle base plate 204.

The side plate may be omitted, if desired. One or more of the lower, middle, and/or upper base plate may be omitted, if desired. One or more of the lower, middle, and/or upper base plate may be combined in functionality, as desired.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A camera mounting assembly for adjustably mounting a camera on a vertical support comprising:
(a) a base member having an upper portion configured to support a lower surface of the camera and a lower portion forming an opposite pair of lower inclined edges;
(b) a side member forming an opposite pair of side inclined edges;
(c) a fastening element configured to detachably fasten together said side member and said base member such that when the lower surface of the camera is supported by the base member, at least a portion of the side member is aligned with a side surface of the camera and configured such that a pair of moveable jaws of a quick-release mechanism is selectively engageable with the lower inclined edges and side inclined edges to adjustably mount the camera in a landscape orientation and a portrait orientation, respectively, while maintaining the camera in a generally centered position over the vertical support, said fastening element comprising a rotatable member accessible from a side surface of said base member when said lower surface of said camera is supported by said base member where rotation of said rotatable member detachably interconnects said side member to said base member when said camera is supported by said base member, said base member and said side member configured in such a manner that when said base member supports said lower surface of said camera said rotatable member is accessible from said side surface of said base member to detach said side member from said base member, said base member being free from extending along a substantial portion of said side surface of said camera when said camera is supported by said base member and said side member is detached from said base member;
(d) said side member capable of lateral movement to a plurality of lateral positions in a generally perpendicular direction with respect to a central axis of the length of said base member in such a manner that said side member is capable of being secured to said base member at said plurality of lateral positions with respect to said base member as a result of selectively rotating said rotatable member to secure to said side member to said base member.

2. The camera mounting assembly of claim 1 wherein said base member includes a plurality of upwardly projecting edges positioned to engage a surface of said camera supported thereon, wherein each of said plurality of upwardly projecting edges has a curved exterior surface positioned to said engage said surface of said camera.

3. The camera mounting assembly of claim 2 wherein said upwardly projecting edges are positioned spaced apart from one another in a manner to engage the same said surface of said camera.

4. The camera mounting assembly of claim 1 wherein said side member includes an elongate slot within which said rotatable member engages therewith.

5. The camera mounting assembly of claim 1 wherein said base member include at least one projection at an end thereof that is engaged with a recess defined by said side member to inhibit said lateral movement.

6. The camera mounting assembly of claim 1 wherein said detachably fasten together said side member and said base member by said fastening element being rotatably secured to a lower base member of said base member.

7. The camera mounting assembly of claim 6 further comprising a middle base member that is slidably engaged with said lower base member such that said middle base member is slidably engaged, in a direction generally aligned with said central axis of the length of said base member, with respect to said lower base member.

8. The camera mounting assembly of claim 7 wherein said lower base member and said middle base member are selectively inhibited from being slidable with respect to one another by a first base fastening member.

9. The camera mounting assembly of claim 7 further comprising an upper base member that is slidably engaged with said middle base member such that said middle base member is slidably engaged, in a direction generally perpendicular to said central axis of the length of said base member.

10. The camera mounting assembly of claim 9 wherein said middle base member and said upper base member are selectively inhibited from being slidable with respect to one another by a second base fastening member.
